(19) United States
(12) Patent Application Publication
(10) Pub. No.: US 2025/0012261 A1
(43) Pub. Date: Jan. 9, 2025

(54) THERMOACOUSTIC CONVERTER

(71) Applicant: DENSO CORPORATION, Kariya-city (JP)

(72) Inventors: Kenji HATTORI, Kariya-city (JP); Mitsunobu NIWA, Kariya-city (JP); Tetsuya MAKIMOTO, Kariya-city (JP)

(21) Appl. No.: 18/891,163

(22) Filed: Sep. 20, 2024

Related U.S. Application Data
(63) Continuation of application No. PCT/JP2023/001456, filed on Jan. 19, 2023.

(30) Foreign Application Priority Data
Mar. 22, 2022 (JP) 2022-045415

(51) Int. Cl. F03G 7/00; F02G 5/02

(52) U.S. Cl. CPC F03G 7/002; F02G 5/02

(57) ABSTRACT

A thermoacoustic converter includes a heater, a cooler, and a thermal storage device. The heater includes a first acoustic wave passage and a high-temperature passage for a first fluid. The cooler includes a second acoustic wave passage and a low-temperature passage for a second fluid. The thermal storage device includes an intermediate acoustic wave passage fluidly connecting between the first acoustic wave passage and the second acoustic wave passage. At least one of the high-temperature passage and the low-temperature passage is defined as a specified passage, and at least one of the first fluid or the second fluid is defined as a specified fluid. The specified passage has a near position close to the thermal storage device, and a far position far from the thermal storage device. The specified passage is configured to allow the specified fluid to flow from the near position to the far position.

### CROSS REFERENCE TO RELATED APPLICATIONS

The present application is a continuation application of International Patent Application No. PCT/JP2023/001456 filed on Jan. 19, 2023, which designated the U.S. and claims the benefit of priority from Japanese Patent Application No. 2022-045415 filed on Mar. 22, 2022. The entire disclosures of all of the above applications are incorporated herein by reference.

### TECHNICAL FIELD

The present disclosure relates to a thermoacoustic converter.

### BACKGROUND

A thermoacoustic converter converts thermal energy into acoustic waves using thermoacoustic phenomena. The acoustic waves produced by the thermoacoustic converter are further converted into other energy such as electricity and used.

### SUMMARY

According to an aspect of the present disclosure, a thermoacoustic converter configured to convert thermal energy to acoustic wave using thermoacoustic phenomena is provided. The thermoacoustic converter includes a heater, a cooler, and a thermal storage device. The heater includes a first acoustic wave passage through which the acoustic wave propagates and a high-temperature passage through which a first fluid flows. The high-temperature passage is disposed around the first acoustic wave passage. The cooler includes a second acoustic wave passage through which the acoustic wave propagates and a low-temperature passage through which a second fluid having a lower temperature than the first fluid flows. The low-temperature passage is disposed around the second acoustic wave passage. The thermal storage device is disposed between the heater and the cooler and includes an intermediate acoustic wave passage which fluidly connects between the first acoustic wave passage and the second acoustic wave passage. At least one of the high-temperature passage and the low-temperature passage is defined as a specified passage. At least one of the first fluid and the second fluid flowing through the specified passage is defined as a specified fluid. The specified passage has a near position that is close to the thermal storage device and a far position that is far from the thermal storage device. The specified passage is configured to allow the specified fluid to flow through the specified passage from the near position to the far position in an axial direction that is parallel to a central axis of the thermal storage device.

### BRIEF DESCRIPTION OF THE DRAWINGS

The above and other objectives, features and advantages of the present disclosure will become more apparent from the following detailed description with reference to the accompanying drawings. In the drawings:

FIG. 1 is an explanatory diagram showing a loop-type thermoacoustic power generator according to a first embodiment;

FIG. 2 is an explanatory diagram showing a thermoacoustic converter according to the first embodiment;

FIG. 3 is a cross-sectional view taken along a line III-III in FIG. 2, showing the thermoacoustic converter according to the first embodiment;

FIG. 4 is a cross-sectional view taken along a line IV-IV in FIG. 2, showing the thermoacoustic converter according to the first embodiment;

FIG. 5 is a cross-sectional view taken along a line V-V in FIG. 2, showing the thermoacoustic converter according to the first embodiment;

FIG. 6 is a cross-sectional view taken along a line VI-VI in FIG. 3, showing the thermoacoustic converter according to the first embodiment;

FIG. 7 is an explanatory diagram showing a straight-type thermoacoustic power generator according to the first embodiment;

FIG. 8 is an explanatory diagram showing another type of the thermoacoustic converter according to the first embodiment;

FIG. 9 is an explanatory diagram showing a thermoacoustic converter according to a second embodiment;

FIG. 10 is a cross-sectional view taken along a line X-X in FIG. 9, showing the thermoacoustic converter according to the second embodiment;

FIG. 11 is a cross-sectional view taken along a line XI-XI in FIG. 9, showing the thermoacoustic converter according to the second embodiment;

FIG. 12 is a cross-sectional view taken along a line XII-XII in FIG. 9, showing the thermoacoustic converter according to the second embodiment;

FIG. 13 is a cross-sectional view taken along a line XIII-XIII in FIG. 10, showing the thermoacoustic converter according to the second embodiment;

FIG. 14 is an explanatory diagram showing another type of the thermoacoustic converter according to the second embodiment;

FIG. 15 is an explanatory diagram showing a thermoacoustic converter according to a third embodiment;

FIG. 16 is a cross-sectional view taken along a line XVI-XVI in FIG. 15, showing the thermoacoustic converter according to the third embodiment;

FIG. 17 is a cross-sectional view taken along a line XVII-XVII in FIG. 15, showing the thermoacoustic converter according to the third embodiment;

FIG. 18 is a cross-sectional view taken along a line XVIII-XVIII in FIG. 15, showing the thermoacoustic converter according to the third embodiment;

FIG. 19 is an explanatory diagram showing a thermoacoustic converter according to a fourth embodiment;

FIG. 20 is a cross-sectional view taken along a line XX-XX in FIG. 19, showing the thermoacoustic converter according to the fourth embodiment;

FIG. 21 is an explanatory diagram showing another type of the thermoacoustic converter according to the fourth embodiment.

### DETAILED DESCRIPTION OF THE PREFERRED EMBODIMENTS

To begin with, examples of relevant techniques will be described.

A thermoacoustic converter converts thermal energy into acoustic waves using thermoacoustic phenomena. The acoustic waves produced by the thermoacoustic converter are further converted into other energy such as electricity and used. The thermoacoustic converter includes a heater, which is a heating heat exchanger, a thermal storage device through which a working fluid as the acoustic wave flows, and a cooler, which is a cooling heat exchanger. The heater is disposed at one end of the thermal storage device and the cooler is disposed at the other end of the thermal storage device, so that fluid flowing through the heater and fluid flowing through the cooler generates a temperature difference between both ends of the thermal storage device. The thermoacoustic converter amplifies the acoustic waves of the working fluid flowing through the thermal storage device using the temperature difference.

Efficient heat exchanges between the fluid in the heater and the working fluid and between the fluid in the cooler and the working fluid are crucial for improving the thermoacoustic conversion efficiency in the thermoacoustic converter. For example, the thermoacoustic device includes a heat conductive member at a center position of a high-temperature portion of a heat exchanger, so that heat is supplied to working fluid not only from an outer circumferential portion of the high-temperature portion of the heat exchanger but also from the center position of the high-temperature portion of the heat exchanger through the heat conductive member. This increases the conversion efficiency of thermal energy into acoustic energy of acoustic waves.

The fluid supplied to the heater heats the working fluid to decrease its temperature and the fluid supplied to the cooler cools the working fluid to increase its temperature. That is, the temperature is highest at an inlet portion of the heater through which the fluid flows into the heater and lowest at an inlet portion of the cooler through which the fluid flows into the cooler. However, in conventional thermoacoustic converters and thermoacoustic devices, the influence of heat distributions in the heater and cooler on heat transfer to the thermal storage device is not taken into consideration. Thus, the thermal acoustic conversion efficiency includes a room for further improvements.

It is an objective of the present disclosure to provide a thermoacoustic converter that can more effectively increase thermoacoustic conversion efficiency by using heat distributions in a heater and a cooler.

According to an aspect of the present disclosure, a thermoacoustic converter configured to convert thermal energy to acoustic wave using thermoacoustic phenomena is provided. The thermoacoustic converter includes a heater, a cooler, and a thermal storage device. The heater includes a first acoustic wave passage through which the acoustic wave propagates and a high-temperature passage through which a first fluid flows. The high-temperature passage is disposed around the first acoustic wave passage. The cooler includes a second acoustic wave passage through which the acoustic wave propagates and a low-temperature passage through which a second fluid having a lower temperature than the first fluid flows. The low-temperature passage is disposed around the second acoustic wave passage. The thermal storage device is disposed between the heater and the cooler and includes an intermediate acoustic wave passage which fluidly connects between the first acoustic wave passage and the second acoustic wave passage. At least one of the high-temperature passage and the low-temperature passage is defined as a specified passage. At least one of the first fluid and the second fluid flowing through the specified passage is defined as a specified fluid. The specified passage has a near position that is close to the thermal storage device and a far position that is far from the thermal storage device. The specified passage is configured to allow the specified fluid to flow through the specified passage from the near position to the far position in an axial direction that is parallel to a central axis of the thermal storage device.

The thermoacoustic converter has one of features in the passage formed in at least one of the heater or the cooler. Specifically, the specified passage, which is at least one of the high-temperature passage or the low-temperature passage, has a structure in which the specified fluid flows in the axial direction that is parallel to the central axis of the thermal storage device from the near position that is close to the thermal storage device to the far position that is far from the thermal storage device. When the high-temperature passage is the specified passage, the first fluid having highest temperature flows at the near position close to the thermal storage device. When the low-temperature passage is the specified passage, the second fluid having lowest temperature flows at the near position close to the thermal storage device.

Thus, at least one of the portion in the heater having highest temperature or the portion in the cooler having lowest temperature faces the thermal storage device. As a result, at least one of heat transfer from the heater to the thermal storage device or heat transfer from the thermal storage device to the cooler can be effectively performed.

Therefore, the thermoacoustic converter of the present disclosure can effectively improve thermoacoustic conversion efficiency by using heat distribution in at least one of the heater or the cooler.

Preferred embodiments of the above-mentioned thermoacoustic converter will be described with reference to the drawings.

### First Embodiment

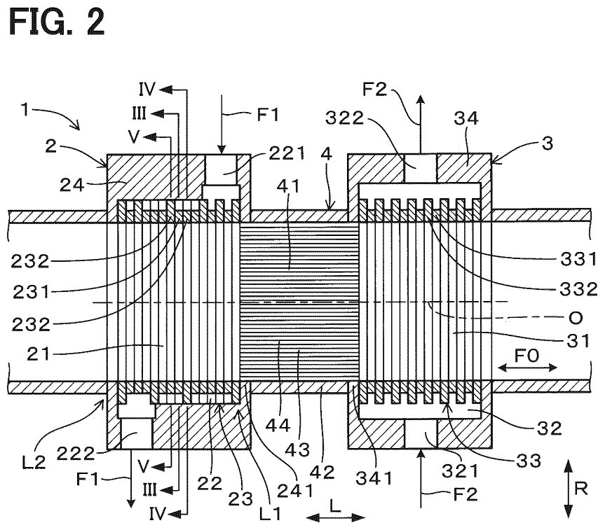

As shown in FIGS. 2 to 6, a thermoacoustic converter 1 of the present embodiment converts thermal energy into acoustic waves using thermoacoustic phenomena. The thermoacoustic converter 1 includes a heater 2 which is a heating heat exchanger, a cooler 3 which is a cooling heat exchanger, and a thermal storage device 4. The heater 2 includes a first acoustic wave passage 21 through which acoustic waves propagates, and a high-temperature passage 22, around the first acoustic wave passage 21, through which a first fluid F1 flows. The cooler 3 includes a second acoustic wave passage 31 through which acoustic waves propagates, and a low-temperature passage 32, around the second acoustic wave passage 31, through which a second fluid F2 having a lower temperature than the first fluid F1 flows. The thermal storage device 4 is disposed between the heater 2 and the cooler 3, and includes an intermediate acoustic wave passage 41 fluidly connecting between the first acoustic wave passage 21 and the second acoustic wave passage 31.

The high-temperature passage 22 of the heater 2 includes a near position L1 that is close to the thermal storage device 4 and a far position that is far from the thermal storage device 4. The high-temperature passage 22 is configured to allow the first fluid F1 to flow in an axial direction L that is parallel to a central axis O of the thermal storage device 4 and the heater 2. The high-temperature passage 22 has axial passages 224 through which the first fluid F1 flows in the axial direction L from the near position L1 toward the far position L2 and circumferential passages 223 through which the first fluid F1 flows in a direction perpendicular to the axial direction. The circumferential passages 223 are also referred to as perpendicular passages. In this embodiment, the high-temperature passage 22 is a specified passage, and the first fluid F1 is a specified fluid.

The thermoacoustic converter 1 of the present embodiment will be explained in detail below.

### (Thermoacoustic Converter 1 and Thermoacoustic Power Generator 5)

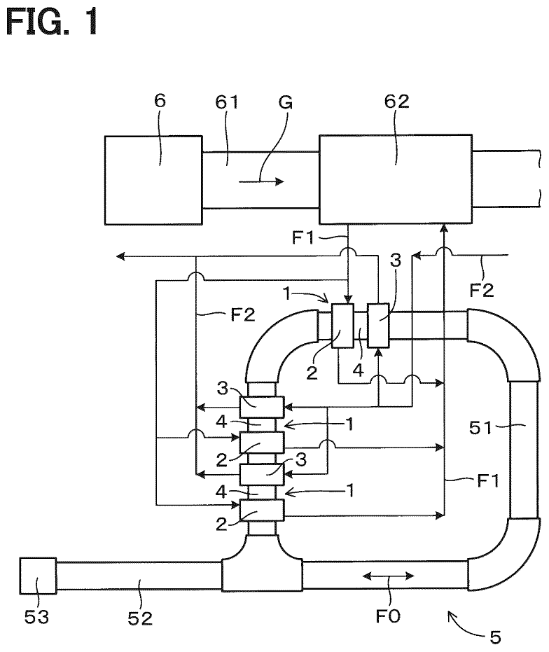

As shown in FIG. 1, the thermoacoustic converter 1 of the present embodiment constitutes a thermoacoustic power generator 5 that generates power by using acoustic waves. One or more of the thermoacoustic converters 1 are disposed in a middle position of a piping that constitutes the thermoacoustic power generator 5. The thermoacoustic power generator 5 of the present embodiment is a loop-type thermoacoustic power generator 5 including an annular pipe 51 that is annularly formed, the thermoacoustic converters 1 disposed in the middle of the annular pipe 51, and a power generator 53 connected to a branch pipe 52 branched from the annular pipe 51.

The thermoacoustic converter 1 is used to amplify acoustic waves caused by a working fluid F0 circulating through the annular pipe 51. The thermoacoustic converter 1 amplifies the acoustic waves caused by the working fluid F0 by expanding and contracting the working fluid F0, which is a gas, using the temperature difference between the both ends of the thermal storage device 4.

The power generator 53 is constituted by a linear power generator that converts vibrations caused by acoustic waves into electricity using electromagnetic induction. The acoustic waves amplified by the thermoacoustic converter 1 are then used by the power generator 53 and converted into electricity.

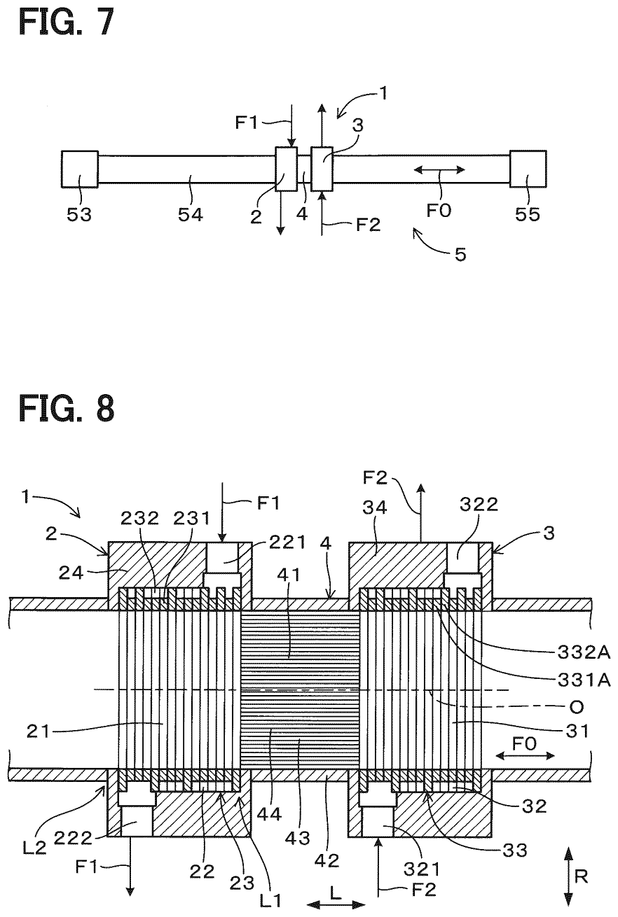

Additionally, as shown in FIG. 7, the thermoacoustic power generator 5 may be a straight-type thermoacoustic power generator that includes a straight pipe 54, which is straightly formed, the thermoacoustic converter 1 arranged in the middle of the straight pipe 54, an acoustic wave generator 55 connected to one end of the straight pipe 54, and the power generator 53 connected to the other end of the straight pipe 54.

### (First Fluid F1 and Second Fluid F2)

As shown in FIG. 1, the first fluid F1 in the present embodiment uses exhaust heat of exhaust gas G supplied from an exhaust heat source 6. Specifically, the first fluid F1 is a heat transfer oil that is heated through heat exchange with the exhaust gas G discharged from the exhaust heat source 6 to an exhaust pipe 61. The exhaust pipe 61 has a heat exchanger 62 for exchanging heat between the exhaust gas G and the heat transfer oil.

The exhaust heat source 6 may be an industrial furnace that heats by burning fuel such as a firing furnace and an aluminum melting furnace. The exhaust heat source 6 may be any of various facilities that emit exhaust gas G through combustion. In the present embodiment, the second fluid F2 is circulating water used in a factory. The second fluid F2 may be any of various fluids having a lower temperature than the exhaust gas G. Further, the temperature of the second fluid F2 is lower than the temperature of the working fluid F0. The working fluid F0 of the thermoacoustic converter 1 and the thermoacoustic power generator 5 in this embodiment is an inert gas such as helium and argon.

In the present embodiment, a direction along a central axis O of the thermal storage device 4 is defined as an axial direction L, a direction around the central axis O of the thermal storage device 4 is defined as a circumferential direction C, and a radial direction with reference to the central axis O of the thermal storage device 4 as a center is defined as a radial direction R. The heater 2 and the cooler 3 are coaxial with the thermal storage device 4, and the central axis O of the thermal storage device 4 is the same as the central axis O of the heater 2 and the central axis O of the cooler 3.

### (Thermal Storage Device 4)

As shown in FIG. 2, the thermal storage device 4 has an outer wall 42 that forms an outer wall of the thermal storage device 4, and a cell wall 44 that is disposed inside the outer wall 42 and defines multiple through holes 43 that pass through the cell wall 44 in the axial direction L. The outer wall 42 has a cylindrical shape. The cell wall 44 has a polygonal shape such as a lattice shape and a honeycomb shape. The thermal storage device 4 is made of a ceramic material. The thermal storage device 4 may be made of a metal material. The multiple through holes 43 defined by the cell wall 44 and the outer wall 42 serve as an intermediate acoustic wave passage 41.

### (Heater 2 and Cooler 3)

As shown in FIGS. 2 to 5, the heater 2 is formed of a first inner wall member 23 that defines the first acoustic wave passage 21 that passes through the first inner wall member 23 in the axial direction L and a first outer wall member 24 that houses the first inner wall member 23 therein. The first outer wall member 24 and the first inner wall member 23 defines a high-temperature passage 22 therebetween. The first outer wall member 24 includes a first inlet 221 through which the first fluid F1 flows into the high-temperature passage 22, and a first outlet 222 through which the first fluid F1 flows out of the high-temperature passage 22. The first inlet 221 is formed at a near position L1 of the first outer wall member 24 that is close to the thermal storage device 4 in the axial direction L, and the first outlet 222 is formed at a far position L2 of the first outer wall member 24 that is far from the thermal storage device 4 in the axial direction L. Specifically, the first inlet 221 and the first outlet 222 are formed at positions of the first outer wall member 24 that are shifted by 180 degrees in the circumferential direction C from each other.

The cooler 3 is formed of a second inner wall member 33 that defines the second acoustic wave passage 31 that passes through the second inner wall member 33 in the axial direction L and a second outer wall member 34 that houses the second inner wall member 33 therein. The second outer wall member 34 and the second inner wall member 33 defines a low-temperature passage 32 therebetween. The second outer wall member 34 includes a second inlet 321 through which the second fluid F2 flows into the low-temperature passage 32, and a second outlet 322 through which the second fluid F2 flows out of the low-temperature passage 32. The second inlet 321 and the second outlet 322 are formed at a middle position of the second outer wall member 34 in the axial direction L. Specifically, the second inlet 321 and the second outlet 322 are formed at positions of the second outer wall member 34 that are shifted by 180 degrees in the circumferential direction C from each other.

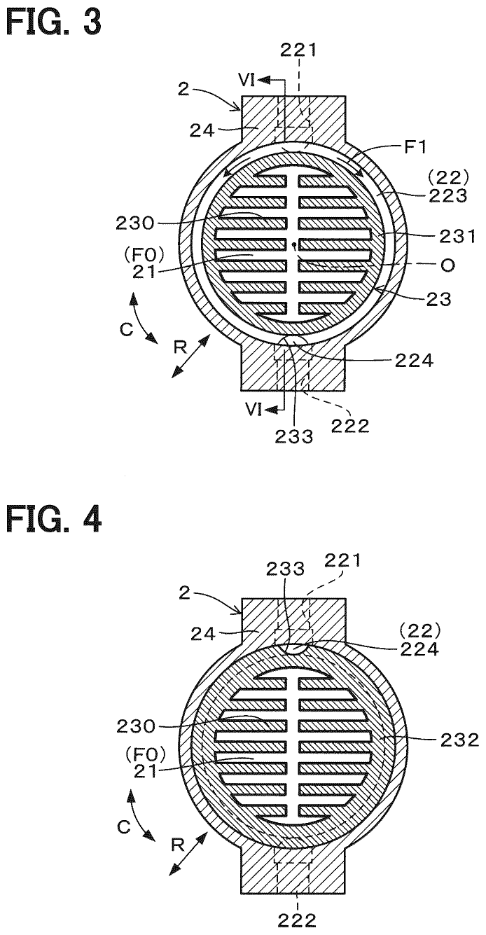

As shown in FIGS. 3 to 5, the high-temperature passage 22 as a specified passage in this embodiment has circumferential passages 223 extending in the circumferential direction C and axial passages 224 extending in the axial direction L. The circumferential passages 223 and the axial passages 224 are alternately arranged in the axial direction L. This configuration allows heat to be effectively transferred from the first fluid F1 flowing through the high-temperature passage 22 of the heater 2 to the working fluid F0 flowing through the first acoustic wave passage 21 of the heater 2.

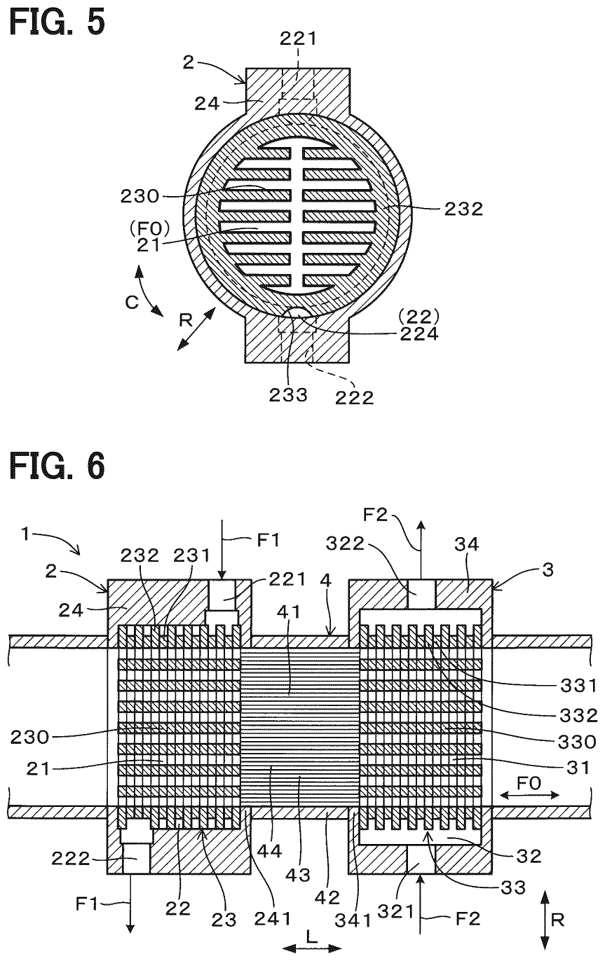

As shown in FIG. 3, each of the circumferential passages 223 is formed as the perpendicular passage. each of the circumferential passages 223 is annularly formed on the outer circumferential side of the first acoustic wave passage 21. Each of the axial passages 224 is a through hole in the axial direction L that is formed on the outer circumferential side of the first acoustic wave passage 21. As shown in FIGS. 4 and 5, adjacent ones of the axial passages 224 are formed respectively at a specific position in the circumferential direction C and at a position that is shifted by 180 degrees in the circumferential direction C from the specific position.

As shown in FIGS. 2 to 6, the first inner wall member 23 of the heater 2 is formed by stacking multiple plates 231, 232 having different outer shapes. The first outer wall member 24 of the heater 2 has a container shape to accommodate the first inner wall member 23. The plates 231, 232 that form the first inner wall member 23 include circumferential plates 231 for defining circumferential passages 223, and axial plates 232 for defining axial passages 224.

Each of the circumferential plates 231 has an outer diameter such that a gap is defined between the inner circumferential surface of the first outer wall member 24 and the circumferential plate 231. The gap serves as the circumferential passage 223. Each of the axial plates 232 has an outer diameter such that the axial plate 232 is in contact with the inner circumferential surface of the first outer wall member 24 and has a notch 233 notched from the outer circumferential surface of the axial plate 232 for defining the axial passage 224. In the heater 2, the circumferential plates 231 and the axial plates 232 are arranged alternately, and the phases of the notches 233 in the adjacent ones of the axial plates 232 are shifted by 180 degrees so that the first fluid F1 sinuously flows through the circumferential passages 223 and the axial passages 224 from the near position L1 to the far position L2 in the axial direction L.

As shown in FIG. 2, some of the circumferential plates 231 and the axial plates 232 located on the inner circumferential side of the first inlet 221 and the first outlet 222 do not have to be arranged alternately. Specifically, the phases of the notches 233 of adjacent ones of the axial plates 232 may be the same on the inner circumferential side of the first inlet 221 and the first outlet 222.

The first fluid F1 flows into the heater 2 through the first inlet 221, branches off to both sides in the circumferential direction C and flows through a gap defined by the outer circumferential surface of the circumferential plate 231 and the axial plates 232. Then, the first fluid F1 flows through the notch 233 of the axial plate 232 in the axial direction L from the near position L1 to the far position L2. The first fluid F1 repeatedly flows as such toward the first outlet 222 and flows out of the heater 2 through the first outlet 222.

The second inner wall member 33 of the cooler 3 is formed by stacking multiple plates 331, 332 having different outer shapes. The second outer wall member 34 of the cooler 3 has a container shape to accommodate the second inner wall member 33. The second inner wall member 33 is formed by alternately stacking small diameter plates 331 having a relatively small outer diameter and large diameter plates 332 having a relatively large outer diameter. The second fluid F2 flows in the circumferential direction, which is perpendicular to the axial direction L, through a gap defined by the outer circumferential surfaces of the small diameter plates 331, the outer circumferential surfaces of the large diameter plates 332, and the inner circumferential surface of the second outer wall member 34.

As shown in FIGS. 3 to 6, the first acoustic wave passage 21 of the heater 2 of this embodiment is formed as gaps defined between multiple heat transfer fins 230 formed on the first inner wall member 23. The first acoustic wave passage 21 passes through the first inner wall member 23 in the axial direction L. The multiple heat transfer fins 230 are formed on the circumferential plates 231 and the axial plates 232.

The second acoustic wave passage 31 of the cooler 3 in this embodiment are formed as gaps between multiple heat transfer fins 330 formed on the second inner wall member 33. The second acoustic wave passage 31 passes through the second inner wall member 33 in the axial direction L. The multiple heat transfer fins 330 are formed on the small diameter plates 331 and the large diameter plates 332.

As shown in FIG. 2 and FIG. 6, each of the heater 2 and the cooler 3 has a facing portion 241, 341 that faces the outer circumferential surface of the end portion of the thermal storage device 4 in the axial direction L. The facing portion 241 of the heater 2 is the end portion in the axial direction L of the first outer wall member 24 which is in contact with the outer circumferential surface of the thermal storage device 4. The facing portion 341 of the cooler 3 is the end portion in the axial direction L of the second outer wall member 34 which is in contact with the outer circumferential surface of the thermal storage device 4. The facing portion 241 of the heater 2 helps the heater 2 heat the outer circumferential surface of the thermal storage device 4. The facing portion 341 of the cooler 3 helps the cooler 3 cool the outer circumferential surface of the thermal storage device 4.

### Effects

The thermoacoustic converter 1 of this embodiment has one of features in the high-temperature passage 22 of the heater 2. Specifically, the high-temperature passage 22 as a specified passage has a structure in which the first fluid F1 flows in the axial direction L from the near position L1 close to the thermal storage device 4 to the far position L2 far from the thermal storage device 4. As a result, the first fluid F1 having highest temperature flows at the near position L1 of the heater 2 that is close to the thermal storage device 4.

Thus, the portion of the heater 2 that has highest temperature faces the thermal storage device 4. As a result, heat can be effectively transferred from the heater 2 to the thermal storage device 4. Therefore, the thermoacoustic converter 1 of this embodiment can effectively improve the thermoacoustic conversion efficiency using the heat distribution in the heater 2.

The first fluid F1 supplied to the high-temperature passage 22 of the heater 2 exchanges heat with the working fluid F0 flowing through the first acoustic wave passage 21 of the heater 2 to decrease its temperature. Thus, the temperature of the first fluid F1 is highest near the first inlet 221 and is lowest near the first outlet 222. In this embodiment, the first fluid F1 having highest temperature flows into the first inlet 221 located at the near position L1 that is close to the thermal storage device 4, thereby increasing the temperature difference between both ends of the thermal storage device 4 in the axial direction L. This increased temperature difference in the thermal storage device 4 enables the working fluid F0 to more actively expand and contract in the thermal storage device 4, and thus the acoustic waves caused by the working fluid F0 can be greatly amplified.

### (Other Configurations)

As shown in FIG. 8, the specified passage may be both the high-temperature passage 22 and the low-temperature passage 32. That is, the second inner wall member 33 and the second outer wall member 34 of the cooler 3 may have structures similar to those of the first inner wall member 23 and the first outer wall member 24 of the heater 2. In this case, the low-temperature passage 32 of the cooler 3 has axial passages through which the second fluid F2 flows in the axial direction L, which is parallel to the central axis O of the thermal storage device 4 and the cooler 3, from a near position L1 of the low-temperature passage 32 that is close to the thermal storage device 4 to a far position L2 of the low-temperature passage 32 that is far from the thermal storage device 4, and perpendicular passages (i.e., circumferential passages) through which the second fluid F2 flows in the direction perpendicular to the axial direction L. The second inner wall member 33 of the cooler 3 is formed by circumferential plates 331A and axial plates 332A.

In this case, the coldest portion of the cooler 3 can face the thermal storage device 4. As a result, heat can be effectively transferred from the thermal storage device 4 to the cooler 3. In addition, the temperature difference between both ends of the thermal storage device 4 in the axial direction L can be further increased, and the acoustic waves caused by the working fluid F0 can be further amplified. Thus, the heat distribution in the heater 2 and the cooler 3 contributes to further improvement of the thermoacoustic conversion efficiency of the thermoacoustic converter 1.

Additionally, the structure of the low-temperature passage 32 in which the circumferential passages and the axial passages are alternately formed in the axial direction L contributes to effective heat transfer from the working fluid F0 flowing through the second acoustic wave passage 31 of the cooler 3 to the second fluid F2 flowing through the low-temperature passage 32 of the cooler 3.

### Second Embodiment

This embodiment shows a thermoacoustic converter in which the configuration of the high-temperature passage 22 of the heater 2 as the specified passage is different from that of the first embodiment. The high temperature passage 22 in the first embodiment meanders such that the phases are shifted by 180 degrees in the circumferential direction C. In this embodiment, the high-temperature passage 22 as the specified passage is formed to meander outward and inward in the radial direction R.

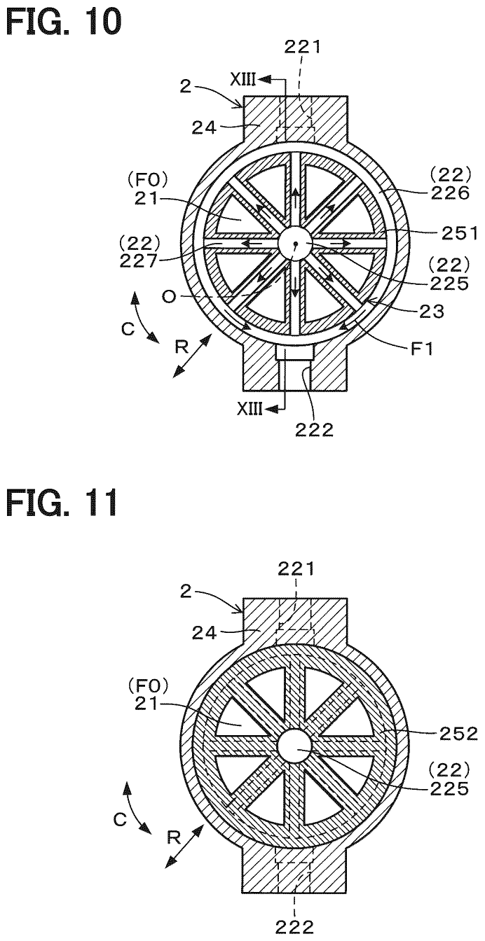

Specifically, as shown in FIGS. 10 to 13, the high-temperature passage 22 in this embodiment has an inner passage 225 that is located at an inner portion of the high-temperature passage 22 in the radial direction R and extends in the axial direction L, outer passages 226 that are located at an outer portion of the high-temperature passage 22 in the radial direction R and extend annularly in the circumferential direction C, and radial passages 227 that fluidly connect between the inner passage 225 and the outer passages 226 and extend in the radial direction R. The inner passage 225 has a part that faces the outer passages 226 in the radial direction R. The radial passages 227 are arranged radially. The radial passages 227 serve as the perpendicular passages, and the inner passage 225 and the outer passages 226 serve as axial passages.

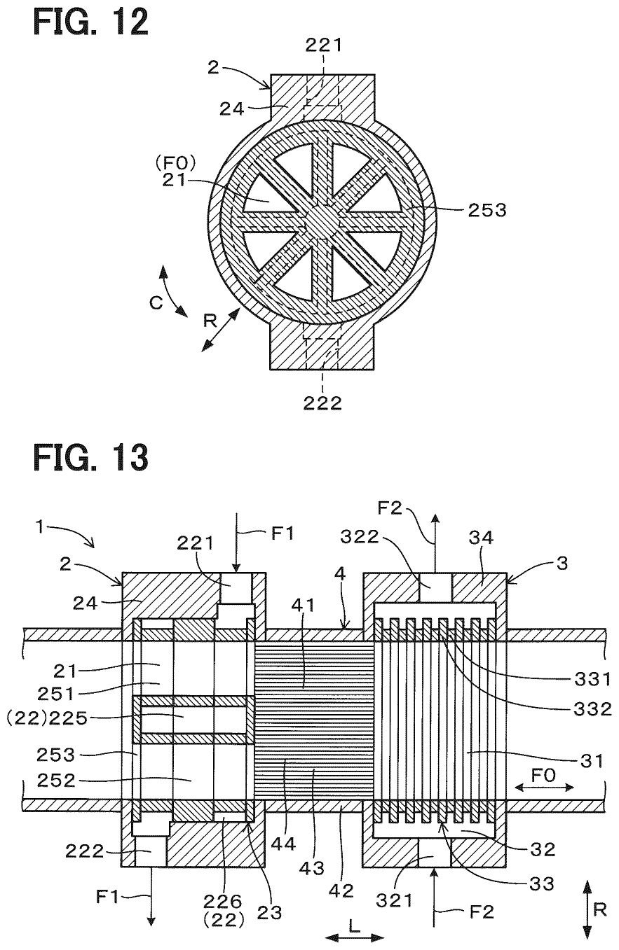

As shown in FIGS. 11 and 12, the inner passage 225 in this embodiment is defined in an inner circumferential portion of the first inner wall member 23 and defined on the inner circumferential side of the first acoustic wave passage 21. Each of the outer passages 226 is annularly defined in an outer circumferential portion of the first inner wall member 23 and defined on the outer circumferential side of the first acoustic wave passage 21. Each of the outer passages 226 is a gap between the outer circumferential surface of the first inner wall member 23 and the inner circumferential surface of the first outer wall member 24.

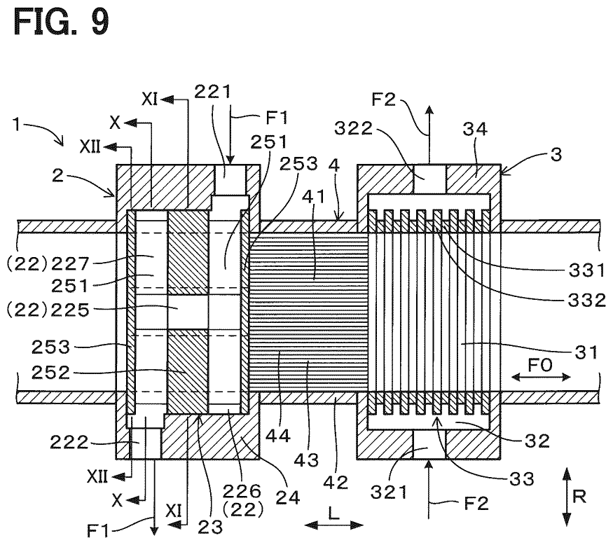

As shown in FIG. 9, the first inner wall member 23 in this embodiment has radial passage forming members 251, an inner passage forming member 252, and blocking members 253. The radial passage forming members 251 define a part of the inner passage 225, the outer passages 226 and the radial passages 227. The inner passage forming member 251 define the other part of the inner passage 225. The blocking members 253 cover and block the inner passage 225. The radial passage forming members 251 and the blocking members 253 are disposed on the inner circumferential side of the portion of the first outer wall member 24 where the first inlet 221 or the first outlet 222 is formed. The inner passage forming member 252 is disposed on the inner circumference side of a portion of the first outer wall member 24 where the first inlet 221 or the first outlet 222 is not formed.

In the heater 2, the inner passage forming member 252 is interposed between the radial passage forming members 251 in the axial direction L, and the radial passage forming members 251 and the inner passage forming member 252 are interposed between the blocking members 253 in the axial direction L. The part of the inner passage 225 defined in the inner passage forming member 252 is fluidly connected to the other part of the inner passage 225 defined in the radial passage forming members 251. Also in this embodiment, the first inlet 221 is formed at the near position L1 of the first outer wall member 24 that is close to the thermal storage device 4 in the axial direction L and the first outlet 222 is formed at the far position L2 of the first outer wall member 24 that is far from the thermal storage device 4 in the axial direction L.

As shown in FIG. 9, the first fluid F1 flows into the heater 2 through the first inlet 221, then flows through the outer passage 226, the radial passages 227, and the inner passage 225 which are defined in the radial passage forming member 251. Specifically, the first fluid F1 flows through the outer passage 226 in the circumferential direction C, flows inward in the radial direction R through the radial passages 227, and flows into the inner passage 225. Then, the first fluid F1 flows through the inner passage 225 defined in the inner passage forming member 252 from the near position L1 toward the far position L2 in the axial direction L, and flows into the inner passage 225, the radial passages 227, and the outer passage 226 defined in the other radial passage forming member 251 such that the first fluid F1 flows through the radial passages 227 outward in the radial direction R and flows through the outer passage 226 in the circumferential direction C. Then, the first fluid F1 flows out of the heater 2 through the first outlet 222.

As shown in FIGS. 10 to 13, the first acoustic wave passage 21 of the heater 2 of this embodiment is multiple passages in the first inner wall member 23 arranged in the circumferential direction C. The multiple passages, as the first acoustic wave passage 21, pass through the radial passage forming members 251, the inner passage forming member 252, and the blocking members 253 in the axial direction L. The radial passages 227 are formed in a radial pattern. The multiple passages as the first acoustic wave passage 21 are formed in a radial pattern. The multiple passages and the radial passages 227 are alternately arranged.

In this embodiment, heat can be effectively transferred from the first fluid F1 flowing through the high-temperature passage 22 of the heater 2 to the working fluid F0 flowing through the first acoustic wave passage 21 of the heater 2. The other configurations of the thermoacoustic converter 1 in this embodiment, such as the thermal storage device 4, the first outer wall member 24 of the heater 2, the cooler 3, are the same as those in the first embodiment.

Other configurations, functions and effects of the thermoacoustic converter 1 of the present embodiment are similar those of the first embodiment. In the present embodiment as well, components indicated by the same reference numerals as those in the first embodiment are the same as those in the first embodiment.

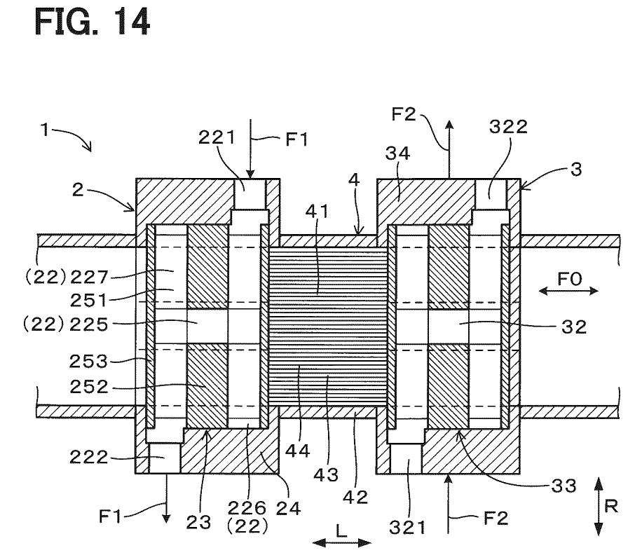

Also in this embodiment, as shown in FIG. 14, both of the high-temperature passage 22 and the low-temperature passage 32 may be the specified passage. That is, the second inner wall member 33 and the second outer wall member 34 of the cooler 3 may have similar structures to those of the first inner wall member 23 and the first outer wall member 24 of the heater 2. In this case, the second fluid F2 in the cooler 3 flows in a meandering manner from the near position L1 of the cooler 3 that is close to the thermal storage device 4 in the axial direction L to the far position L2 of the cooler 3 that is far from the thermal storage device 4 in the axial direction L while flowing inward and outward in the radial direction R. As a result, heat can be effectively transferred from the thermal storage device 4 to the cooler 3.

### Third Embodiment

This embodiment shows a thermoacoustic converter 1 in which the configuration of the high-temperature passage 22 of the heater 2 as the specified passage is different from those in the first and second embodiments. The high-temperature passage 22 of the heater 2 in this embodiment is formed around the first acoustic wave passage 21 and is configured to allow the first fluid F1 to flow in a meandering manner from the near position L1 to the far position L2 in the axial direction L while flowing inward and outward in a wavy manner in the radial direction R.

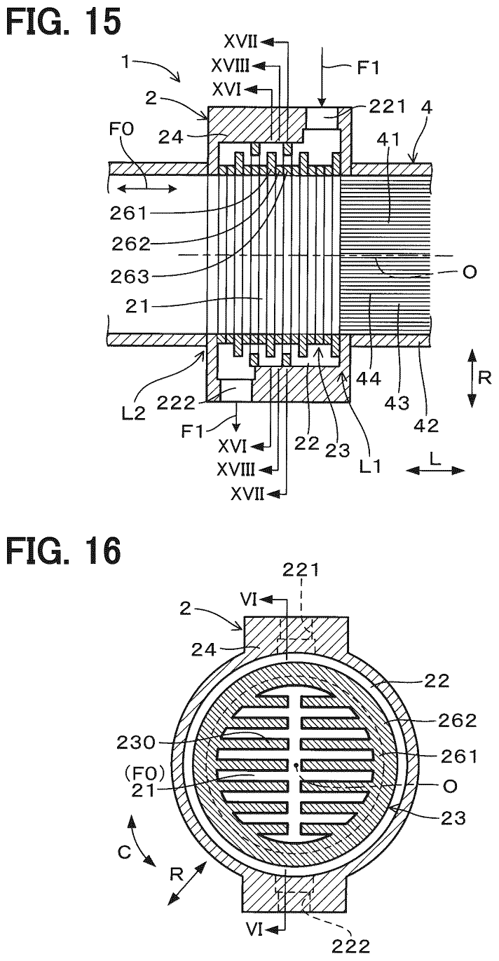

Specifically, as shown in FIGS. 15 to 18, the high-temperature passage 22 is formed by arranging annular inner baffle plates 262 and annular outer baffle plates 264 in the axial direction L. The annular inner baffle plates 262 are located on the inner circumferential portion of the high-temperature passage 22 in the radial direction R and extends annularly in the circumferential direction C. The annular outer baffle plates 264 are located on the outer circumferential portion of the high-temperature passage 22 in the radial direction R and extends annularly in the circumferential direction C. The annular outer baffle plates 264 and the annular inner baffle plates 262 are arranged to shift in the axial direction L from each other. Thereby, the first fluid F1 sinuously flows from the near position L1 to the far position L2 in the axial direction L while flowing inward and outward in the radial direction R.

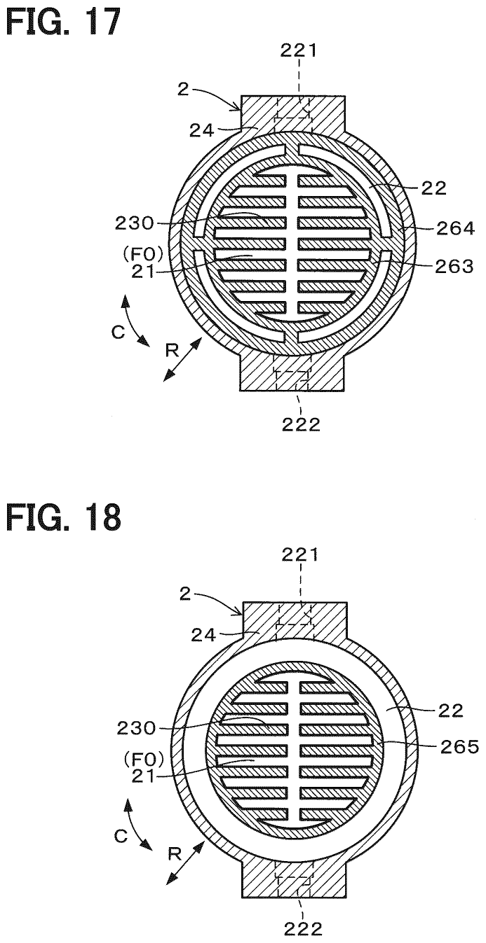

The first inner wall member 23 forming the high-temperature passage 22 is formed of inner circumferential stacking plates 261 each having the annular inner baffle plate 262 as shown in FIG. 16, outer circumferential stacking plates each having the annular outer baffle plate 264 as shown in FIG. 17, and intermediate stacking plates 265 each disposed between the inner circumferential stacking plate 261 and the outer circumferential stacking plate 263 in the axial direction L. The intermediate stacking plates 265 are arranged such that the inner circumferential stacking plates 261 and the outer circumferential stacking plates 263 are arranged alternately. For example, the inner circumferential stacking plate 261, the intermediate stacking plate 265, the outer circumferential stacking plate 263, and the intermediate stacking plate 265 are arranged in this order as a set and multiple of the set are arranged repeatedly. Thereby, the first fluid F1 flows in a meandering manner from the near position L1 to the far position L2 in the axial direction L around the first acoustic wave passage 21.

As shown in FIG. 15, in the high-temperature passage 22, a gap between the outer circumferential surfaces of the inner circumferential stacking plates 261 and the inner circumferential surfaces of the outer circumferential stacking plates 263 serves as an axial passage through which the first fluid F1 flows in the axial direction L. In addition, a gap between the inner circumferential stacking plates 261 and the outer circumferential stacking plates 263 in the axial direction L serves as a perpendicular passage through which the first fluid F1 flows in a direction perpendicular to the axial direction L. The first fluid F1 flows into the heater 2 through the first inlet 221, sinuously flows through the gap between the inner circumferential stacking plates 261 and the outer circumferential stacking plates 263, and flows out of the heater 2 through the first outlet 222.

In this embodiment as well, heat can be effectively transferred from the first fluid F1 flowing through the high-temperature passage 22 of the heater 2 to the working fluid F0 flowing through the first acoustic wave passage 21 of the heater 2. The other configurations of the thermoacoustic converter 1 in this embodiment, such as the thermal storage device 4, the first outer wall member 24 of the heater 2, the cooler 3, are the same as those in the first embodiment. In FIG. 15, the description of the cooler 3 is omitted.

Other configurations, functions and effects of the thermoacoustic converter 1 of the present embodiment are similar to those of the first embodiment. In the present embodiment as well, components indicated by the same reference numerals as those in the first embodiment are the same as those in the first embodiment.

Also in this embodiment, both of the high-temperature passage 22 and the low-temperature passage 32 may be the specified passage. That is, the second inner wall member 33 and the second outer wall member 34 of the cooler 3 may have the same structure as those of the first inner wall member 23 and the first outer wall member 24 of the heater 2. In this case, the second fluid F2 in the cooler 3 flows in a meandering manner from the near position L1 to the far position L2 in the axial direction L around the second acoustic wave passage 31. As a result, heat can be effectively transferred from the thermal storage device 4 to the cooler 3.

### Fourth Embodiment

This embodiment shows a thermoacoustic converter 1 in which the configuration of the high-temperature passage 22 as the specified passage of the heater 2 is different from those in the first to third embodiments. The high-temperature passage 22 of the heater 2 in this embodiment is configured to allow the first fluid F1 to flow from the near position L1 to the far position L2 in the axial direction L around the first acoustic wave passage 21 while flowing spirally around the central axis O of the thermal storage device 4 and the central axis O of the heater 2.

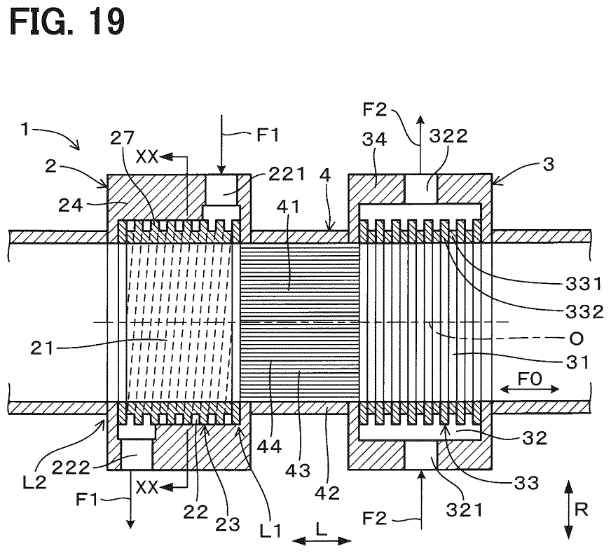

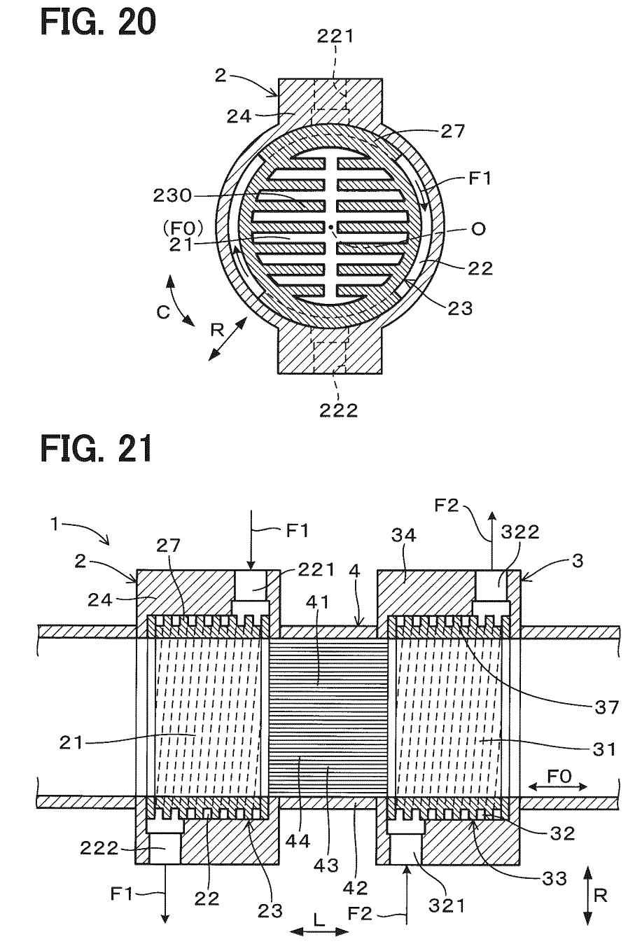

As shown in FIGS. 19 and 20, the first inner wall member 23 that forms the high-temperature passage 22 in this embodiment has spiral protrusions 27 formed on its outer surface. Each of the spiral protrusions 27 has an outer diameter that is in contact with the inner surface of the first outer wall member 24. The first fluid F1 flows into the heater 2 through the first inlet 221, flows spirally through the gap defined by the first inner wall member 23, the first outer wall member 24, and the spiral protrusions 27 from the near position L1 to the far position L2 in the axial direction L, and then flows out of the heater 2 through the first outlet 222.

In this embodiment as well, heat can be effectively transferred from the first fluid F1 flowing through the high-temperature passage 22 of the heater 2 to the working fluid F0 flowing through the first acoustic wave passage 21 of the heater 2. The other configurations of the thermoacoustic converter 1 in this embodiment, such as the thermal storage device 4, the first outer wall member 24 of the heater 2, the cooler 3, are the same as those in the first embodiment.

Other configurations, functions and effects of the thermoacoustic converter 1 of the present embodiment are similar to those of the first embodiment. In the present embodiment as well, components indicated by the same reference numerals as those in the first embodiment are the same as those in the first embodiment.

Also in this embodiment, as shown in FIG. 21, both of the high-temperature passage 22 and the low-temperature passage 32 may be the specified passage. That is, the second inner wall member 33 and the second outer wall member 34 of the cooler 3 may have the same structure as those of the first inner wall member 23 and the first outer wall member 24 of the heater 2. In this case, the second inner wall member 33 of the cooler 3 has spiral protrusions 37. In this case, the second fluid F2 in the cooler 3 spirally flows around the second acoustic wave passage 31 from the near position L1 to the far position L2 in the axial direction L. Therefore, heat can be effectively transferred from the thermal storage device 4 to the cooler 3.

The cross-sectional areas of the high-temperature passage 22 and the low-temperature passage 32 in each of the first to fourth embodiments may be appropriately set to ensure smooth flow of the first fluid F1 or the second fluid F2. The cross-sectional areas of the high-temperature passage 22 and the low-temperature passage 32 in FIGS. 2 to 21 of the first to fourth embodiments are shown diagrammatically just as examples.

The present disclosure is not limited to each embodiment, and it is possible to configure further different embodiments without departing from the gist of the present disclosure. Further, the present disclosure includes various modifications, modifications within the equivalence, and the like. Furthermore, the technical idea of the present disclosure further includes various combinations and various forms of constitutional elements that are derivable from the present disclosure.

Although the present disclosure has been described in accordance with the embodiments, it is understood that the present disclosure is not limited to such embodiments or structures. The present disclosure encompasses various modifications and variations within the scope of equivalents. In addition, while the various elements are shown in various combinations and configurations, which are exemplary, other combinations and configurations, including more, less or only a single element, are also within the spirit and scope of the present disclosure.

1. A thermoacoustic converter configured to convert thermal energy to acoustic wave using thermoacoustic phenomena, the thermoacoustic converter comprising:
a heater including:
a first acoustic wave passage through which the acoustic wave propagates; and
a high-temperature passage through which a first fluid flows, the high-temperature passage being disposed around the first acoustic wave passage;
a cooler including:
a second acoustic wave passage through which the acoustic wave propagates; and
a low-temperature passage through which a second fluid having a lower temperature than the first fluid flows, the low-temperature passage being disposed around the second acoustic wave passage; and
a thermal storage device disposed between the heater and the cooler and includes an intermediate acoustic wave passage which fluidly connects between the first acoustic wave passage and the second acoustic wave passage, wherein
at least one of the high-temperature passage or the low-temperature passage is defined as a specified passage,
at least one of the first fluid or the second fluid flowing through the specified passage is defined as a specified fluid,
the specified passage has a near position that is close to the thermal storage device in an axial direction that is parallel to a central axis of the thermal storage device, and a far position that is far from the thermal storage device in the axial direction,
the specified passage is configured to allow the specified fluid to flow through the specified passage from the near position to the far position in the axial direction.

2. The thermoacoustic converter according to claim 1, wherein
the specified passage has:
circumferential passages each of which extends in a circumferential direction of the central axis of the thermal storage device; and
axial passages each of which extends in the axial direction, and
the circumferential passages and the axial passages are arranged alternately in the axial direction and fluidly connected to each other.

3. The thermoacoustic converter according to claim 1, wherein
the specified passage has:
an inner passage which extends in the axial direction, the inner passage being defined at an inner portion of the specified passage in a radial direction with respect to the central axis of the thermal storage device as a center;
outer passages each of which has an annular shape and extends in a circumferential direction of the central axis of the thermal storage device, the outer passages being defined at an outer portion of the specified passage in the radial direction; and
radial passages each of which extends in the radial direction and fluidly connects between the inner passage and the outer passages, wherein
the inner passage has a part that faces the outer passages in the radial direction.

4. The thermoacoustic converter according to claim 1, wherein
the specified passage is disposed around the first acoustic wave passage and includes:
annular inner baffle plates each of which has an annular shape and extends in a circumferential direction of the central axis, the annular inner baffle plates being disposed in an inner circumferential portion of the specified passage in a radial direction with respect to the central axis of the thermal storage device as a center; and
annular outer baffle plates each of which has an annular shape in the circumferential direction, the annular outer baffle plates being disposed in an outer circumferential portion of the specified passage in the radial direction,
the annular inner baffle plates and the annular outer baffle plates are arranged to be shifted in the axial direction such that the specified fluid flows in a meandering manner through the specified passage from the near position to the far position.

5. The thermoacoustic converter according to claim 1, wherein
the specified passage is disposed around the first acoustic wave passage, and
the specified passage is configured to allow the specified fluid to spirally flow through the specified passage around the central axis of the thermal storage device.

6. The thermoacoustic converter according to claim 1, wherein
the thermal storage device has an end portion in the axial direction, and
at least one of the heater or the cooler includes a facing portion that faces an outer circumferential surface of the end portion of the thermal storage device.

7. The thermoacoustic converter according to claim 1, wherein
the high-temperature passage is the specified passage,
the first fluid is heated using an exhaust gas supplied from an exhaust heat source, and
the thermoacoustic converter constitutes a thermoacoustic power generator configured to generate power using the acoustic wave.

8. The thermoacoustic converter according to claim 1, wherein
the specified passage has:
an inlet through which the specified fluid flows into the specified passage; and
an outlet through which the specified fluid flows out of the specified passage, and
the inlet is formed at the near position that is close to the thermal storage device and the outlet is formed at the far position that is far from the thermal storage device.

9. The thermoacoustic converter according to claim 5, wherein
the heater includes an outer wall member and an inner wall member,
a gap between the outer wall member and the inner wall member serves as the high-temperature passage,
the specified passage is the high-temperature passage, and
the inner wall member includes a spiral protrusion on an outer circumferential surface of the inner wall member such that the first fluid as the specified fluid spirally flows through the gap from the near position to the far position.

10. The thermoacoustic converter according to claim 6, wherein
the facing portion is in contact with the outer circumferential surface of the end portion of the thermal storage device.
